(19) United States
(12) Patent Application Publication
(10) Pub. No.: US 2017/0206558 A1
(43) Pub. Date: Jul. 20, 2017

(54) BEACON SYSTEM

(71) Applicant: TOSHIBA TEC KABUSHIKI KAISHA, Tokyo (JP)

(72) Inventors: Yumiko OOKUMA, Nakano Tokyo (JP); Masanori SANBE, Mishima Shizuoka (JP); Kenji SHIMIZU, Mishima Shizuoka (JP)

(21) Appl. No.: 15/406,445

(22) Filed: Jan. 13, 2017

(30) Foreign Application Priority Data
Jan. 15, 2016 (JP) 2016-006474

(51) Int. Cl. G06Q 30/02; H04W 4/00

(52) U.S. Cl. CPC G06Q 30/0261; H04W 4/008; G06Q 30/0267; H04W 4/023

(57) ABSTRACT

A beacon system improves relevance of content delivered to a display device. The beacon system includes transmitters at different locations, first and second servers, and a portable terminal. The portable terminal receives a unique beacon ID signal from one of the transmitters at a first location, generates a first request signal from the unique beacon ID signal, and transmits the first request signal to the first server. The first server generates a first response signal in response to the first request signal. The portable terminal receives the first response signal, generates a second request signal from the first response signal, and transmits the second request signal to the second server. The second server generates a second response signal in response to the second request signal. The portable terminal receives the second response signal and displays content that is relevant to the first location on a display unit thereof.

### CROSS-REFERENCE TO RELATED APPLICATION

This application is based upon and claims the benefit of priority from Japanese Patent Application No. 2016-006474, filed Jan. 15, 2016, the entire contents of which are incorporated herein by reference.

### FIELD

Embodiments described herein relate generally to a beacon system.

### BACKGROUND

In recent years, marketing activities such as advertising, publicity and promotional activities are carried out for visiting customers in retail stores such as supermarkets. For example, in retail stores, marketing activities are carried out for visiting customers by using digital signage located in the retail stores.

However, since the digital signage terminals are expensive and a location also needs to be ensured, the introduction of digital signage terminals is not easy.

### DESCRIPTION OF THE DRAWINGS

FIG. 1 is an explanatory diagram illustrating an example of a configuration of a beacon system according to a first embodiment.

FIG. 2 is a block diagram illustrating an example of a hardware configuration of a beacon transmitter.

FIG. 3 is a block diagram illustrating an example of a hardware configuration of a portable terminal.

FIG. 4 is a block diagram illustrating an example of a hardware configuration of a beacon server.

FIG. 5 is a block diagram illustrating an example of a hardware configuration of a content server.

FIG. 6 is a flowchart illustrating an example of a display process.

FIG. 7 is an explanatory diagram illustrating an example of screen transition of a content screen.

FIG. 8 is a flowchart illustrating an example of an extraction process.

FIG. 9 is an explanatory diagram illustrating an example of a configuration of a beacon system according to a second embodiment.

FIG. 10 is a block diagram illustrating an example of a hardware configuration of a portable terminal.

FIG. 11 is a block diagram illustrating an example of a hardware configuration of a beacon server.

FIG. 12 is a block diagram illustrating an example of a hardware configuration of an electronic receipt server.

FIG. 13 is a block diagram illustrating an example of a hardware configuration of a recommendation server.

FIG. 14 is a flowchart illustrating an example of a display process.

FIG. 15 is an explanatory diagram illustrating an example of screen transition of an electronic receipt application start-up screen.

FIG. 16 is a flowchart illustrating an example of an extraction process.

FIG. 17 is an explanatory diagram illustrating an example of a configuration of a beacon system according to a third embodiment.

FIG. 18 is a block diagram illustrating an example of a hardware configuration of a portable terminal.

FIG. 19 is a block diagram illustrating an example of a hardware configuration of a beacon server.

FIG. 20 is a block diagram illustrating an example of a hardware configuration of a content server.

FIG. 21 is a block diagram illustrating an example of a hardware configuration of a recommendation server.

FIG. 22 is a flowchart illustrating an example of a display process.

FIG. 23 is a flowchart illustrating an example of an extraction process.

FIG. 24 is a flowchart illustrating an example of a content extraction process.

### DETAILED DESCRIPTION

Embodiments provide a beacon system which facilitate marketing for visiting customers.

According to an embodiment, a beacon system that improves relevance of content delivered to a display device, includes a plurality of beacon transmitters at different locations, each beacon transmitter configured to wirelessly transmit a unique beacon ID signal using a short distance wireless communication protocol, a first server device, a second server device, and a portable terminal having a first communication interface configured to wirelessly communicate with other devices using the short distance wireless communication protocol, and a second communication interface configured to wirelessly connect to a network for communication with the first and second server devices. The portable terminal, in response to receiving through the first communication interface, a unique beacon ID signal from one of the transmitters at a first location, generates a first request signal from the unique beacon ID signal, and transmits the first request signal to the first server device. The first server device, in response to the first request signal, generates a first response signal, and transmits the first response signal to the portable terminal. The portable terminal, in response to receiving through the second communication interface, the first response signal, generates a second request signal from the first response signal, and transmits the second request signal to the second server device. The second server device, in response to the second request signal, generates a second response signal, and transmits the second response signal to the portable terminal. The portable terminal, in response to receiving through the second communication interface, the second response signal, displays content that is relevant to the first location on a display unit thereof.

Below, embodiments of a beacon system will be described in detail with reference to accompanying drawings. Embodiments described below are an embodiment of a beacon system, and is not intended to limiting. The following description will be given for an example in which a beacon system are applied to beacon systems which are introduced at retail stores such as supermarkets.

### First Embodiment

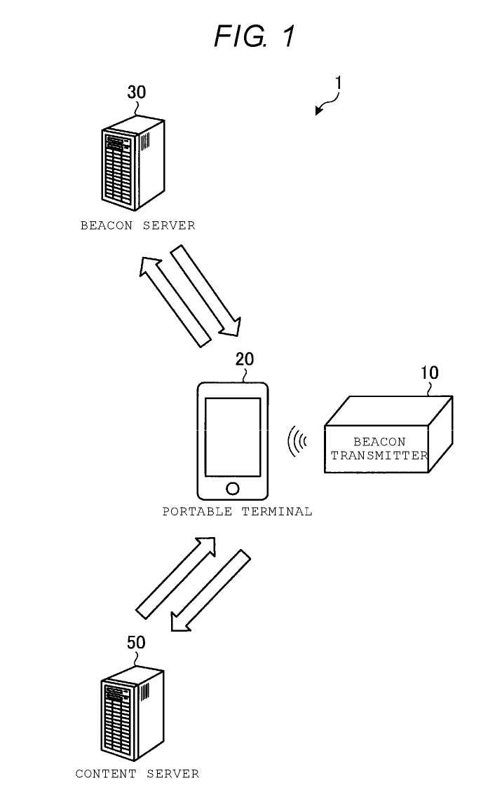

FIG. 1 is an explanatory diagram illustrating an example of a configuration of a beacon system 1 according to a first embodiment. The beacon system 1 according to the first embodiment includes a beacon transmitter 10, a portable terminal 20, a beacon server 30, and a content server 50.

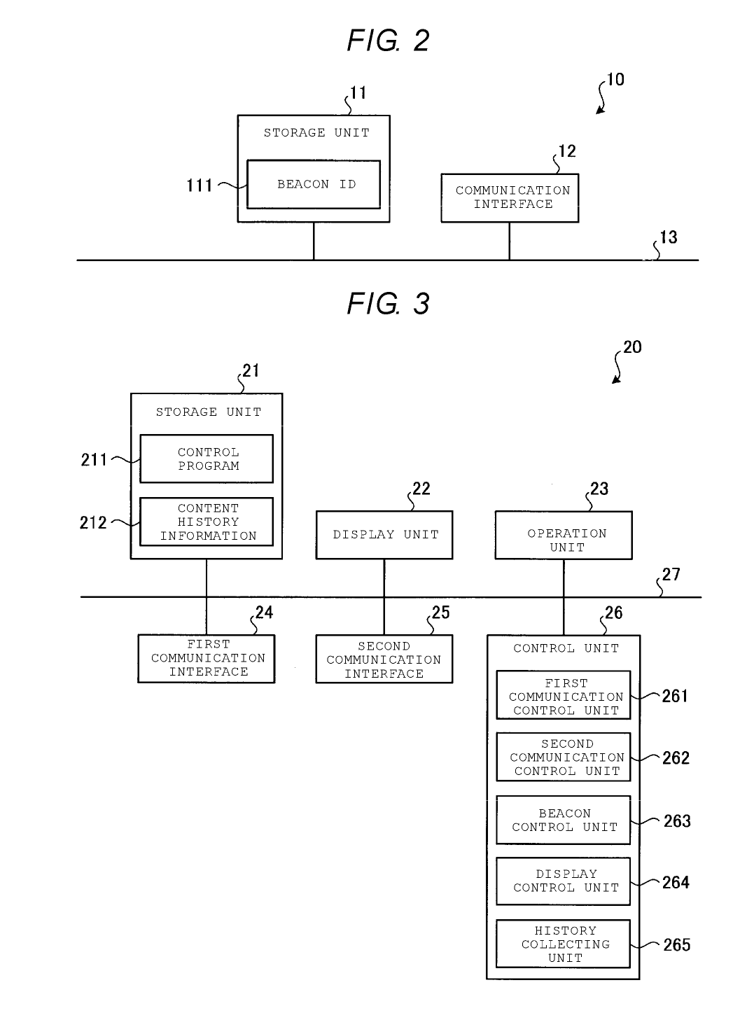

A single or a plurality of beacon transmitters 10 are located, for example, in predetermined locations of a retail store. Further, the location of the beacon transmitter 10 is not limited to the retail store, but may be public locations such as streets, and stations. The beacon transmitter 10 is a transmission device transmitting a beacon ID 111 (see FIG. 2) to a single or a plurality of unspecified portable terminals 20. Here, the beacon ID 111 is transmitter identification information capable of identifying the beacon transmitter 10. The beacon ID 111 may be a set of a plurality of pieces of identification information. For example, the beacon ID 111 may include a set of a retail store ID for identifying a retail store, a store ID for identifying each store of a retail store, and a location ID for identifying a location.

The portable terminal 20 is owned by a customer. The portable terminal 20 displays various content information which is provided from the beacon system 1. More specifically, the portable terminal 20 receives the beacon ID 111 transmitted from the beacon transmitter 10. The portable terminal 20 transmits the received beacon ID 111 or the like, to the beacon server 30. The portable terminal 20 receives a processing content corresponding to the beacon ID 111, or the like, from the beacon server 30. The portable terminal 20 transmits the received processing content to the content server 50. The portable terminal 20 receives content information corresponding to the processing content from the content server 50. The portable terminal 20 displays content information to enhance customer's purchase motivation.

The beacon server 30 stores the processing content corresponding to the beacon ID 111. More specifically, the beacon server 30 receives the beacon ID 111 or the like from the portable terminal 20. The beacon server 30 transmits the processing content corresponding to the received beacon ID 111, or the like, to the portable terminal 20. The number of beacon servers 30 may be one, or a plurality of beacon servers may perform a function in cooperation with each other.

The content server 50 stores various content information which is displayed on the portable terminal 20. The content server 50 transmits content information corresponding to the processing content which is requested by the portable terminal 20, to the portable terminal 20. The number of content servers 50 may be one, or a plurality of content servers may perform a function in cooperation with each other.

Next, the hardware configuration of respective devices included in the beacon system 1 will be described.

FIG. 2 is a block diagram illustrating an example of a hardware configuration of the beacon transmitter 10. The beacon transmitter 10 includes a storage unit 11, and a communication interface 12. The storage unit 11 and the communication interface 12 are connected to each other through a system bus 13.

The storage unit 11 may be a storage device that is a semiconductor memory device such as a random access memory (RAM), a read only memory (ROM), and a flash memory. The storage unit 11 stores the beacon ID 111 for identifying the beacon transmitter 10, or the like.

The communication interface 12 which is a transmission unit transmits the beacon ID 111 which is stored in the storage unit 11 to unspecified number portable terminals 20 through short-distance wireless communication. For example, the communication interface 12 performs communication by using wireless communication techniques such as Bluetooth® or BLE (Bluetooth® Low Energy). As used herein, “short distance” means a distance up to 10 meters.

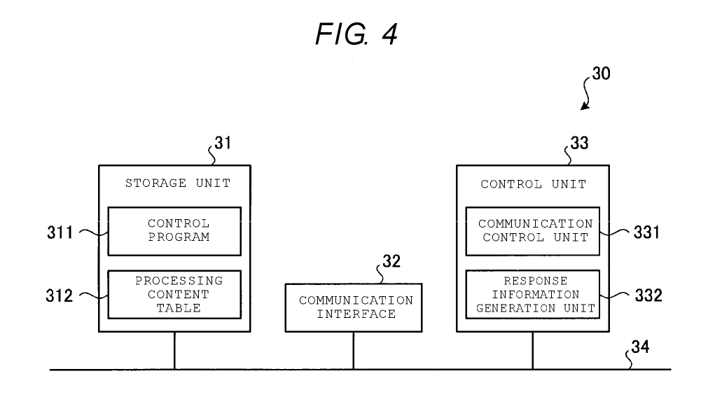

FIG. 3 is a block diagram illustrating an example of a hardware configuration of the portable terminal 20. The portable terminal 20 includes a storage unit 21, a display unit 22, an operation unit 23, a first communication interface 24, a second communication interface 25, and a control unit 26. The storage unit 21, the display unit 22, the operation unit 23, the first communication interface 24, the second communication interface 25, and the control unit 26 are connected to each other through a system bus 27.

The storage unit 21 is a storage device such as a hard disk drive (HDD) or a solid state drive (SSD). The storage unit 21 stores a control program 211 and content history information 212.

The control program 211 performs functions included in the portable terminal 20 or an operating system.

The content history information 212 is history of the content information which is displayed on the display unit 22. The content history information 212 stores date and time information, a content name, and storage destination information in association with each other. The date and time information indicates date and time when the content information is displayed on the display unit 22. The content name is the name of the content information which is displayed on the display unit 22. The storage destination information indicates the storage destination of the content information. For example, the storage destination information is information such as a uniform resource locator (URL) in which the content information is stored.

The display unit 22 is, for example, a liquid crystal display or the like. The operation unit 23 is, for example, a touch panel which is stacked on the display unit 22. Alternatively, the operation unit 23 may be buttons provided on a casing.

The first communication interface 24 receives the beacon ID 111 which is transmitted from the beacon transmitter 10 through short-distance wireless communication. More specifically, the first communication interface 24 performs communication by using wireless communication techniques such as Bluetooth® or BLE.

The second communication interface 25 is an interface for connection to respective devices, through a network such as the Internet.

The control unit 26 controls the operation of the entire portable terminal 20 so as to achieve various functions included in the portable terminal 20. The control unit 26 includes a central processing unit (CPU), a read only memory (ROM), and a random access memory (RAM). The CPU performs control of the operations of the portable terminal 20. The ROM is a storage medium that stores various programs and data. The RAM is a storage medium that temporarily stores the various programs, or for rewriting various data. The CPU executes programs stored in the ROM or the storage unit 21, with the RAM as a work area.

Since the CPU of the control unit 26 executes the control program 211 of the storage unit 21 in the RAM, the CPU implements each functional unit illustrated in FIG. 3. Specifically, the control unit 26 includes a first communication control unit 261, a second communication control unit 262, a beacon control unit 263, a display control unit 264, and a history collecting unit 265, as functional units, and the program steps executed by each of the functional unites are further described below.

The first communication control unit 261 controls the first communication interface 24 so as to receive the beacon ID 111 from the beacon transmitter 10.

The second communication control unit 262 controls the second communication interface 25 so as to communicate with respective devices which are connected to the network.

If the first communication control unit 261 receives the beacon ID 111, the beacon control unit 263 controls the execution of the processing content corresponding to the beacon ID 111. Specifically, if the beacon ID 111 is received, the beacon control unit 263 causes the second communication control unit 262 to transmit first beacon information towards the beacon server 30. Here, the first beacon information contains at least the beacon ID 111. Further, the first beacon information contains beacon strength indicating the radio field strength when receiving the beacon ID 111. If the beacon server 30 is caused to transmit the first beacon information, the beacon control unit 263 causes the second communication control unit 262 to receive first response information which is transmitted from the beacon server 30. Here, the first response information contains information for notifying of the processing content corresponding to the first beacon information. For example, the first response information contains information for notifying of a process of displaying content information, a process of requesting start-up of an application, a process of requesting a point grant, or the like, as the processing content.

The beacon control unit 263 causes the second communication control unit 262 to transmit first content request information containing the processing content which is transmitted through the first response information, towards the content server 50. Here, the first content request information requests content information corresponding to the processing content of first response information. If the content server 50 is caused to transmit the first content request information, the beacon control unit 263 causes the second communication control unit 262 to receive content information which is transmitted from the content server 50. If the second communication control unit 262 receives content information, the beacon control unit 263 controls the display control unit 264 to display the content information.

The display control unit 264 controls the display unit 22 so as to display various screens. For example, if the second communication control unit 262 receives the content information, the display control unit 264 displays content information.

The history collecting unit 265 stores the history of the content information which is displayed on the display control unit 264, in the content history information 212. More specifically, the history collecting unit 265 stores date and time information, content names, and storage destination information in the content history information 212, as a history of content information that a customer viewed. If the history to be displayed is selected from the content history information 212, the history collecting unit 265 causes the display control unit 264 to display content information indicated by the storage destination information of history. Thus, for example, if a customer performs shopping based on the content information such as a recipe in a retail store, the customer can view the content information even after returning home.

FIG. 4 is a block diagram illustrating an example of a hardware configuration of the beacon server 30. The beacon server 30 includes a storage unit 31, a communication interface 32, and a control unit 33. The storage unit 31, the communication interface 32, and the control unit 33 are connected to each other through a system bus 34.

The storage unit 31 is a storage device such as an HDD or an SSD. The storage unit 31 stores a control program 311 and a processing content table 312.

The control program 311 performs functions included in the beacon server 30 or an operating system.

In the processing content table 312, a beacon area and a processing content are associated and stored for each beacon ID 111 of each beacon transmitter 10. The beacon area is information indicating an area from the beacon transmitter 10 to a predetermined distance. In this embodiment, the beacon area functions depending on whether the processing content indicated by the beacon ID 111 is executed. It is possible to configure a single or a plurality of areas for the beacon area. For example, the beacon area is divided into three areas. In this case, the beacon area may be divided into a first area from the beacon transmitter 10 to about radius 2 centimeters, a second area from the beacon transmitter 10 to about radius 1 meter, and a third area from the beacon transmitter 10 to about radius 10 meter. In this case, the first area is used in a case of displaying content information on the portable terminal 20 of a customer who moves the portable terminal 20 close to the beacon transmitter 10. The third area is used in a case of displaying content information on the portable terminal 20 of a customer who visits a retail store.

The processing content is information indicating the processing content corresponding to the beacon ID 111 which is transmitted from the beacon transmitter 10. For example, the processing content represents the process of displaying content information, the process of requesting start-up of an application, the process of requesting a point grant, a process of requesting a coupon grant, or the like. In the case of the process of displaying content information, the processing content contains information capable of identifying signage information, recipe information, and social networking service (SNS) information which are displayed as content information. In the case of the process of requesting start-up of an application, the processing content contains information for designating an application to be started. In the case of the process of requesting a point grant, the processing content contains a point value to be granted. In the case of the process of requesting a coupon grant, the processing content contains information capable of identifying coupon information to be granted. It is preferable that a process corresponding to a location of the beacon transmitter 10 is set in the processing content. For example, in a case of locating the beacon transmitter 10 in a vegetable section, it is preferable that a process of displaying content information on vegetable and a process of granting a coupon of vegetable are set in the processing content. Incidentally, the processing content may be complex ones that require a plurality of processes. For example, the processing content may include the process of displaying content information and the process of requesting a coupon grant.

The communication interface 32 is an interface for connection to respective devices, through a network such as the Internet.

The control unit 33 controls the operation of the entire beacon server 30 so as to achieve various functions included in the control unit 33. The control unit 33 includes a CPU, a ROM, and a RAM. The CPU performs control of the operations of the beacon server 30. The ROM is a storage medium that stores various programs and data. The RAM is a storage medium that temporarily stores the various programs, or rewrites various data. The CPU executes programs stored in the ROM or the storage unit 31, with the RAM as a work area.

Since the CPU of the control unit 33 executes the control program 311 of the storage unit 31 in the RAM, the CPU implements each functional unit illustrated in FIG. 4. Specifically, the control unit 33 includes a communication control unit 331 and a response information generation unit 332, as functional units, and the program steps executed by each of the functional units are further described below.

The communication control unit 331 controls the communication interface 32 so as to communicate with respective devices which are connected to the network.

If the first beacon information is received, the response information generation unit 332 controls the generation of first response information corresponding to the first beacon information. Specifically, the response information generation unit 332 determines whether or not a beacon ID 111 matching the beacon ID 111 of the received first beacon information is registered in the processing content table 312. If the beacon ID 111 is registered, the response information generation unit 332 determines whether or not the portable terminal 20 is present within the beacon area associated with the matching beacon ID 111 in the processing content table 312. In this case, the response information generation unit 332 determines the position of the portable terminal 20, based on the beacon strength contained in the first beacon information. If the portable terminal 20 is present within the beacon area, the response information generation unit 332 extracts a processing content associated with the matching beacon ID 111. The response information generation unit 332 generates first response information containing the extracted processing content. The response information generation unit 332 causes the communication control unit 331 to transmit the generated first response information, to the portable terminal 20. In addition, if there is no corresponding processing content, the response information generation unit 332 transmits first response information indicating that there is no corresponding processing content.

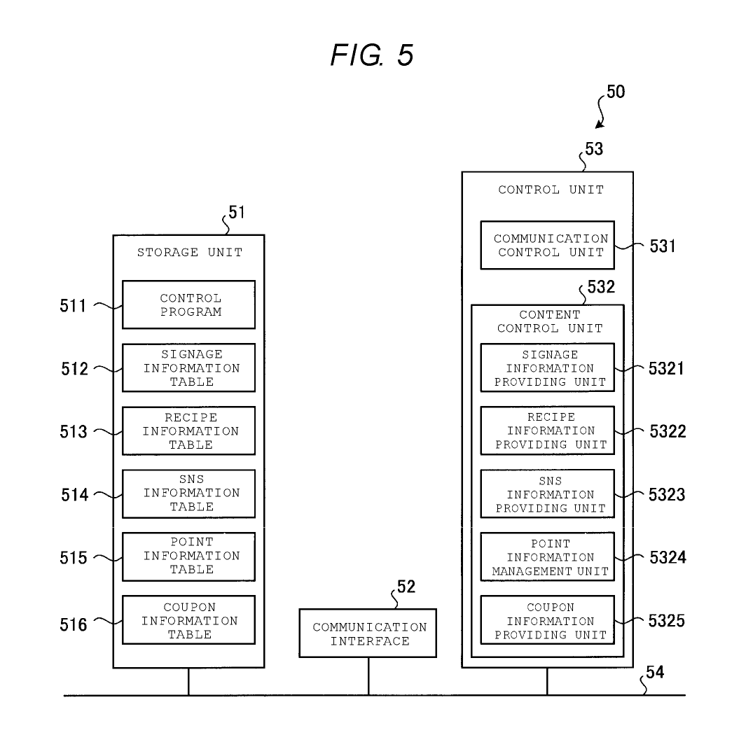

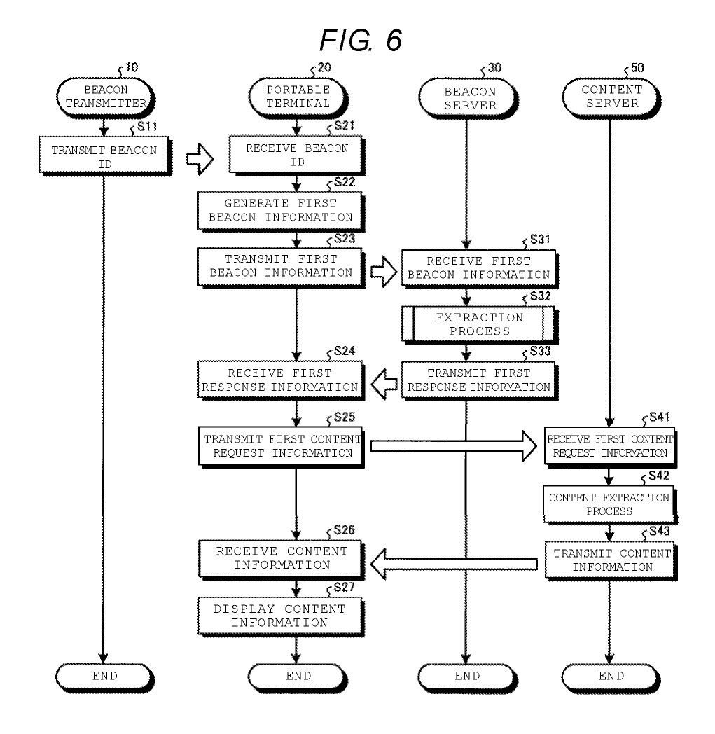

FIG. 5 is a block diagram illustrating an example of a hardware configuration of the content server 50. The content server 50 includes a storage unit 51, a communication interface 52, and a control unit 53. The storage unit 51, the communication interface 52, and the control unit 53 are connected to each other through a system bus 54.

The storage unit 51 is a storage device such as an HDD or an SSD. The storage unit 51 stores a control program 511, a signage information table 512, a recipe information table 513, a SNS information table 514, a point information table 515, and a coupon information table 516.

The control program 511 performs functions included in the content server 50 or an operating system.

In the signage information table 512, signage information is stored for each piece of signage identification information capable of identifying signage information. The signage information enhances customer's purchase motivation. More specifically, the signage information is the price of merchandise, information indicating discounted merchandise, information for introducing merchandise, and information for introducing how to use merchandise. Further, the signage information may be a still image or a moving image.

In the recipe information table 513, recipe information is stored for each piece of recipe identification information capable of identifying recipe information. The recipe information relates to a recipe using food stuff which is merchandise. Further, the recipe information may be a still image or a moving image.

In the SNS information table 514, SNS information is stored for each piece of SNS identification information capable of identifying SNS information. The SNS information introduces merchandise which is uploaded to SNS. Further, the SNS information may be a still image or a moving image.

In the point information table 515, a point is stored for each piece of identification information capable of identifying a customer. Here, for example, the point is to be granted to a customer who visits a store. The point can be used instead of the price of purchase of merchandise.

In the coupon information table 516, coupon information is stored for each piece of coupon identification information capable of identifying a coupon. Here, the coupon information imparts benefits to a customer who owns the coupon. More specifically, coupon information for discounting the sale price of merchandise and coupon information for giving goods, rights, or the like are stored in the coupon information table 516.

The communication interface 52 is an interface for connection to respective devices, through a network such as the Internet.

The control unit 53 controls the operation of the entire content server 50 so as to achieve various functions included in the control unit 53. The control unit 53 includes a CPU, a ROM, and a RAM. The CPU performs control of the operations of the content server 50. The ROM is a storage medium that stores various programs and data. The RAM is a storage medium that temporarily stores the various programs, or rewrites various data. The CPU executes programs stored in the ROM or the storage unit 51, with the RAM as a work area.

Since the CPU of the control unit 53 executes the control program 511 of the storage unit 51 in the RAM, the CPU implements each functional unit illustrated in FIG. 5 on the RAM. Specifically, the control unit 53 includes a communication control unit 531 and a content control unit 532, as functional units, and the program steps executed by each of the functional unites are further described below.

The communication control unit 531 controls the communication interface 52 so as to communicate with respective devices which are connected to the network.

If the communication control unit 531 receives the first content request information, the content control unit 532 extracts content information corresponding to the processing content contained in the first content request information. Specifically, the content control unit 532 extracts content information corresponding to the processing content, in cooperation with a single or a plurality of functional units included in the content control unit 532. In other words, the content control unit 532 extracts a single or a plurality of various information which are extracted by the respective functional units, as content information. Alternatively, the content control unit 532 may extract content information corresponding to the processing content, by combining each of the various information which are extracted by the plurality of functional units. The content control unit 532 causes the communication control unit 531 to transmit the extracted content information, to the portable terminal 20. The content control unit 532 includes a signage information providing unit 5321, a recipe information providing unit 5322, an SNS information providing unit 5323, a point information management unit 5324, and a coupon information providing unit 5325.

The signage information providing unit 5321 extracts signage information from the signage information table 512, based on the processing content of the first content request information. For example, the signage information providing unit 5321 extracts signage information associated with the signage identification information indicated by the processing content of the first content request information. Thus, the signage information providing unit 5321 extracts signage information that is intended by a person who generates the processing content table 312. Therefore, the signage information providing unit 5321 can extract signage information for enhancing purchase motivation for predetermined merchandise.

The recipe information providing unit 5322 extracts recipe information from the recipe information table 513, based on the processing content of the first content request information. For example, the recipe information providing unit 5322 extracts recipe information associated with the recipe identification information indicated by the processing content of the first content request information. Thus, the recipe information providing unit 5322 extracts recipe information that is intended by a person who generates the processing content table 312. Therefore, the recipe information providing unit 5322 can extract recipe information for enhancing purchase motivation for predetermined merchandise.

The SNS information providing unit 5323 extracts SNS information from the SNS information table 514, based on the processing content of the first content request information. For example, the SNS information providing unit 5323 extracts SNS information associated with the SNS identification information indicated by the processing content of the first content request information. Alternatively, the SNS information providing unit 5323 extracts SNS information which is described for merchandise indicated by the processing content of the first content request information. Thus, the SNS information providing unit 5323 extracts SNS information that is intended by a person who generates the processing content table 312. Therefore, the SNS information providing unit 5323 can extract SNS information for enhancing purchase motivation for predetermined merchandise.

The point information management unit 5324 grants a point to a customer corresponding to the point information table 515, based on the processing content of the first content request information. The point information management unit 5324 performs extraction by granting a point to a customer or generating content information indicating the granted point value.

The coupon information providing unit 5325 extracts coupon information from the coupon information table 516, based on the processing content of the first content request information. For example, the coupon information providing unit 5325 extracts coupon information associated with the coupon identification information indicated by the processing content of the first content request information. Thus, the coupon information providing unit 5325 extracts coupon information that is intended by a person who generates the processing content table 312. Therefore, the coupon information providing unit 5325 can extract coupon information for enhancing purchase motivation for predetermined merchandise.

Next, a display process executed by respective devices in the beacon system 1 will be described. Here, FIG. 6 is a flowchart illustrating an example of a display process executed by respective devices in the beacon system 1 according to the first embodiment.

First, the beacon transmitter 10 transmits a beacon ID 111 (step S11).

Next, the first communication control unit 261 of the portable terminal 20 receives the beacon ID 111 (step S21). Next, the beacon control unit 263 of the portable terminal 20 generates first beacon information (step S22). Next, the second communication control unit 262 of the portable terminal 20 transmits the first beacon information (step S23).

Next, the communication control unit 331 of the beacon server 30 receives the first beacon information (step S31). Next, the beacon server 30 executes an extraction process which will be described later (step S32). Next, the communication control unit 331 of the beacon server 30 transmits first response information (step S33).

Next, the second communication control unit 262 of the portable terminal 20 receives the first response information (step S24). Next, the second communication control unit 262 of the portable terminal 20 transmits the first content request information (step S25).

Next, the communication control unit 531 of the content server 50 receives the first content request information (step S41). Next, the content control unit 532 of the content server 50 executes a content extraction process in response to the first content request information (step S42). In other words, the content control unit 532 extracts content information to be transmitted to the portable terminal 20, in response to the first content request information. Alternatively, the content control unit 532 executes point granting or the like. If the point granting is executed, the content control unit 532 extracts content information indicating that a point is granted. Next, the communication control unit 531 of the content server 50 transmits content information (step S43).

Next, the second communication control unit 262 of the portable terminal 20 receives the content information (step S26). Next, the display control unit 264 of the portable terminal 20 displays the received content information (step S27).

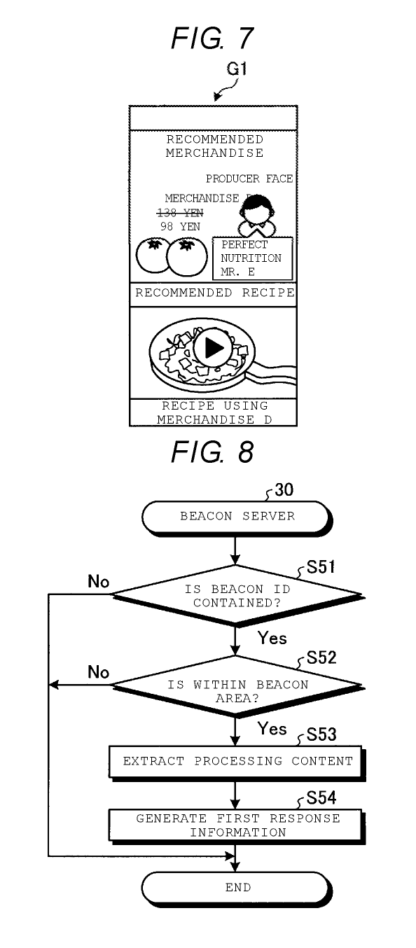

For example, if content information is received which is extracted based on the first beacon information transmitted from the beacon transmitter 10 located on a merchandise shelf in a retail store, the display control unit 264 displays a content screen G1. Here, FIG. 7 is an explanatory diagram illustrating an example of screen transition of the content screen G1. The content screen G1 illustrated in FIG. 7 displays content information of merchandise which is recommended by a retail store, from the beacon transmitter 10 which is located in the merchandise shelf. For example, the display control unit 264 displays signage information, recipe information, SNS information, coupon information, granting of a point, or the like, as the content screen G1.

Thus, the display process executed by respective devices in the beacon system 1 according to the first embodiment is ended.

Next, an extraction process executed by the beacon server 30 of the beacon system 1 according to the first embodiment will be described. Here, FIG. 8 is a flowchart illustrating an example of an extraction process executed by the beacon server 30 of the beacon system 1 according to the first embodiment.

First, the response information generation unit 332 of the beacon server 30 determines whether or not a beacon ID 111 matching the beacon ID 111 contained in the received first beacon information is registered in the processing content table 312 (step S51). If the matching beacon ID 111 is not registered in the processing content table 312 (step S51; No), the response information generation unit 332 of the beacon server 30 ends the extraction process.

Meanwhile, if the matching beacon ID 111 is registered in the processing content table 312 (step S51; Yes), the response information generation unit 332 of the beacon server 30 determines whether or not the portable terminal 20 is present within the beacon area (step S52). In other words, the response information generation unit 332 of the beacon server 30 determines whether or not the portable terminal 20 is present within the beacon area associated with the matching beacon ID 111 in the processing content table 312. If the portable terminal 20 is not present within the beacon area (step S52; No), the response information generation unit 332 of the beacon server 30 ends the extraction process.

Meanwhile, if the portable terminal 20 is present within the beacon area (step S52; Yes), the response information generation unit 332 of the beacon server 30 extracts a processing content (step S53). Next, the response information generation unit 332 of the beacon server 30 generates first response information (step S54).

Thus, the extraction process executed by respective devices in the beacon system 1 according to the first embodiment is ended.

As described above, the portable terminal 20 according to the first embodiment receives the beacon ID 111 transmitted from the transmitter located in a predetermined location. The second communication control unit 262 of the portable terminal 20 transmits the first beacon information to the beacon server 30. The first communication control unit 261 receives the first response information indicated by the processing content corresponding to the beacon ID 111, as the response to the first beacon information. The first communication control unit 261 transmits first content request information for requesting content information corresponding to the processing content indicated by the first response information. The first communication control unit 261 receives content information, as a response to the first content request information. The display control unit 264 displays the content information on the display unit 22. At this time, the portable terminal 20 can cause display the content information on marketing to be displayed. Thus, the portable terminal 20 can easily perform marketing for the visiting customer.

### Second Embodiment

Next, a beacon system 2 according to a second embodiment will be described. In the following description, a difference from the first embodiment will be mainly described. The components having the same function as in the first embodiment are denoted by the same names and reference numerals as in the first embodiment, and the description thereof will be omitted.

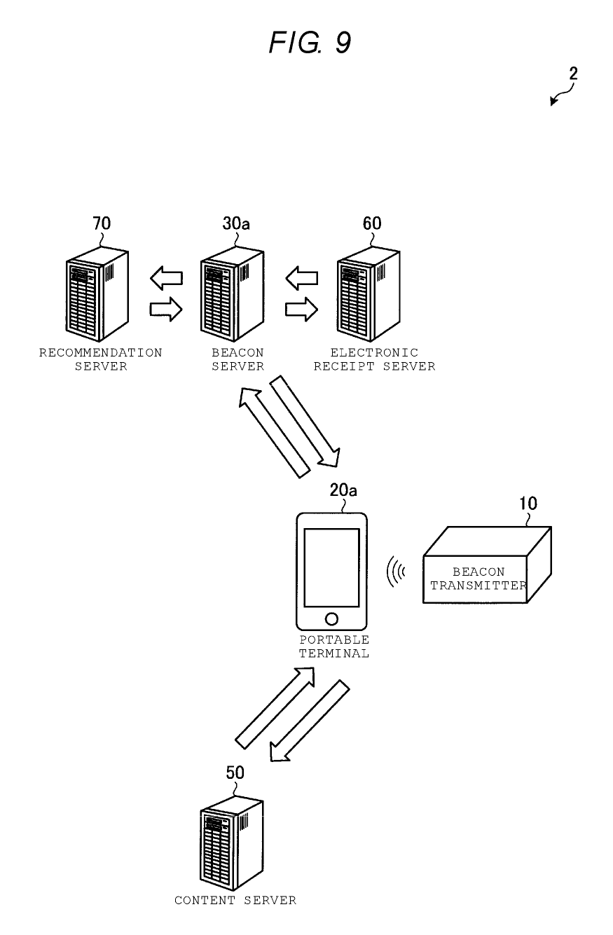

Here, FIG. 9 is an explanatory diagram illustrating an example of a configuration of the beacon system 2 according to the second embodiment. The beacon system 2 includes a portable terminal 20a and a beacon server 30a, instead of the portable terminal 20 and the beacon server 30. Further, the beacon system 2 includes an electronic receipt server 60, and a recommendation server 70.

The electronic receipt server 60 which is a third server device manages electronic receipt information obtained by computerizing a receipt having purchase information on one transaction printed thereon, for each customer. The electronic receipt server 60 stores attribute information indicating the attributes of a customer. The recommendation server 70 executes a recommendation process for extracting a processing content corresponding to the attributes of a customer. In other words, the beacon system 2 according to the second embodiment can execute the processing content corresponding to the attributes of a customer.

In addition, in the present embodiment, a description is given, with the beacon server 30a, the content server 50, the electronic receipt server 60, and the recommendation server 70 as separate server devices, but it is not limited thereto. For example, a single server device may achieve the functions included in the beacon server 30a, the electronic receipt server 60, and the recommendation server 70. Further, another server device may achieve the respective functions of the beacon server 30a, the content server 50, the electronic receipt server 60, and the recommendation server 70.

Next, the hardware configuration of respective devices included in the beacon system 2 according to the second embodiment will be described.

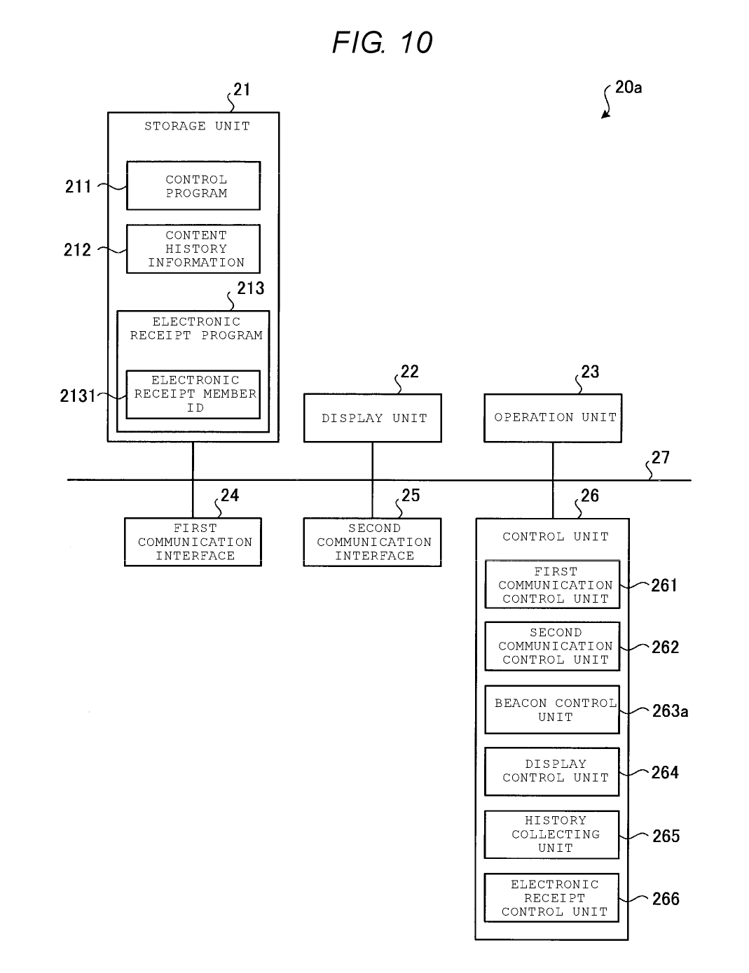

The hardware configuration of the portable terminal 20a according to the second embodiment will be described. FIG. 10 is a block diagram illustrating an example of the hardware configuration of the portable terminal 20a according to the second embodiment.

The storage unit 21 of the portable terminal 20a according to the second embodiment stores an electronic receipt program 213. The electronic receipt program 213 performs functions relating to the electronic receipt. In other words, the electronic receipt program 213 relates to an electronic receipt application. Further, the electronic receipt program 213 includes an electronic receipt member ID 2131 for identifying a customer who is registered as a member to receive a service relating to an electronic receipt. In other words, the electronic receipt member ID 2131 is user identification information capable of identifying each user, such as a customer using the portable terminal 20a, who registers attribute in advance to receive a service relating to an electronic receipt.

Since the CPU of the control unit 26 executes the control program 211 of the storage unit 21 in the RAM, the CPU implements each functional unit illustrated in FIG. 10. Specifically, the control unit 26 includes a first communication control unit 261, a second communication control unit 262, a beacon control unit 263a, a display control unit 264, a history collecting unit 265, and an electronic receipt control unit 266, as functional units, and the program steps executed by each of the functional unites are further described below.

The beacon control unit 263a according to the second embodiment causes the second communication control unit 262 to transmit second beacon information obtained by adding the electronic receipt member ID 2131 for identifying the attribute of a user using the portable terminal 20a to the first beacon information. In other words, the second beacon information includes at least a beacon ID 111, a beacon strength, and the second beacon information having the electronic receipt member ID 2131.

If the second beacon information is transmitted, the beacon control unit 263a causes the second communication control unit 262 to receive first response information indicated by the processing content corresponding to the attribute information of a customer which is transmitted from the beacon server 30a. The beacon control unit 263a determines whether or not the processing content indicated by the first response information is a processing content of requesting start-up of an electronic receipt application. If the processing content is not first response information for requesting the start-up of an electronic receipt application, the beacon control unit 263a transmits the first content request information to the beacon server 30a, similar to the first embodiment. If the content server 50 is caused to transmit the first content request information, the beacon control unit 263a receives content information which is transmitted from the content server 50. In contrast, if the processing content is the first response information for requesting the start-up of an electronic receipt application, the beacon control unit 263a displays a screen for confirming whether or not to start up the electronic receipt application, on the display control unit 264.

The electronic receipt control unit 266 displays electronic receipt information containing purchase information on one transaction or the like, on the display control unit 264.

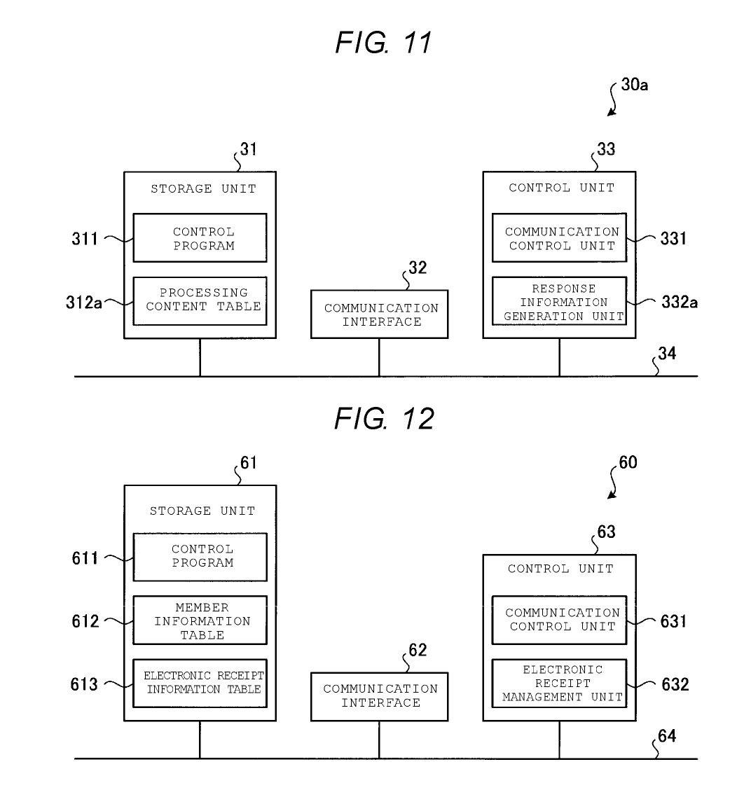

The hardware configuration of the beacon server 30a according to the second embodiment will be described. FIG. 11 is a block diagram illustrating an example of the hardware configuration of the beacon server 30a according to the second embodiment.

The storage unit 31 of the beacon server 30a according to the second embodiment stores a processing content table 312a according to the second embodiment. In the processing content table 312a according to the second embodiment, a beacon area and a processing content candidate are associated for each beacon ID 111. The processing content candidate is a candidate for the processing content corresponding to the beacon ID 111 which is transmitted from the beacon transmitter 10. In other words, the processing content candidate is a single or a plurality of processing contents which are candidates. For example, the processing content candidate maybe a combination of a single or a plurality of processing contents for each of which content information of different merchandise is displayed. Alternatively, the processing content candidate may be a combination of a single or a plurality of processing contents to grant a different point for each of the processing content. Alternatively, the processing content candidate may be a combination of a single or a plurality of processing contents to grant coupon information of a different discount rate for each of the processing content. Alternatively, the processing content candidate may be a combination of the process of displaying content information, the process of requesting start-up of an application, and the process of requesting a point grant.

Since the CPU of the control unit 33 executes the control program 311 of the storage unit 31 in the RAM, the CPU implements each functional unit illustrated in FIG. 11. Specifically, the control unit 33 includes a communication control unit 331 and a response information generation unit 332a, as functional units, and the program steps executed by each of the functional unites are further described below.

The response information generation unit 332a according to the second embodiment determines whether or not a beacon ID 111 matching the beacon ID 111 of the received second beacon information is registered in the processing content table 312a. If the matching beacon ID 111 is registered, the response information generation unit 332a determines whether or not the portable terminal 20a is present within the beacon area associated with the matching beacon ID 111 in the processing content table 312a. If it is determined that the portable terminal 20a is present within the beacon area, the response information generation unit 332a extracts a processing content candidates associated with the matching beacon ID 111.

The response information generation unit 332a causes the communication control unit 331 to transmit the electronic receipt member ID 2131 contained in the second beacon information, to the electronic receipt server 60. Thus, the response information generation unit 332a extracts the attribute information of a customer of the electronic receipt member ID 2131.

Further, if the communication control unit 331 receives the attribute information as the response to the electronic receipt member ID 2131, the response information generation unit 332a extracts the processing content candidate associated with the beacon ID 111. If the processing content candidate is extracted, the response information generation unit 332a generates first recommendation request information containing the processing content candidate and the attribute information. The response information generation unit 332a causes the communication control unit 331 to transmit the generated first recommendation request information, to the recommendation server 70. Thus, the response information generation unit 332a, which is an extraction unit, extracts the processing content corresponding to the attribute information which is specified by the electronic receipt member ID 2131 and the beacon ID 111. In other words, the electronic receipt member ID 2131 functions as information capable of specifying the attribute of a user. The response information generation unit 332a causes the communication control unit 331 to receive the processing content corresponding to the attribute information. The response information generation unit 332a generates first response information containing the processing content corresponding to the attribute information. For example, the response information generation unit 332a generates the first response information containing the processing content representing the content information of merchandise corresponding to the attribute information. Alternatively, the response information generation unit 332a generates first response information containing the processing content granting a point corresponding to the attribute information. Alternatively, the response information generation unit 332a generates first response information containing the processing content granting coupon information of a discount rate corresponding to the attribute information.

Next, the hardware configuration of the electronic receipt server 60 will be described.

Here, FIG. 12 is a block diagram illustrating an example of a hardware configuration of the electronic receipt server 60. The electronic receipt server 60 includes a storage unit 61, a communication interface 62, and a control unit 63. The storage unit 61, the communication interface 62, and the control unit 63 are connected to each other through a system bus 64.

The storage unit 61 is a storage device such as an HDD or an SSD. The storage unit 61 stores a control program 611, a member information table 612, and an electronic receipt information table 613.

The control program 611 performs functions included in the electronic receipt server 60 or an operating system.

In the member information table 612, attribute information is associated and stored for each electronic receipt member ID 2131. The electronic receipt member ID 2131 is identification information capable of identifying a customer using an electronic receipt. The attribute information is the attribute of the customer using an electronic receipt. For example, the attribute information is information such as gender, age, birthday, height, weight, a body mass index (BMI) value, and the rank of a customer. The rank of the customer is determined by the total amount of money of merchandise that a customer purchases, a rank which is determined by whether or not a customer is enrolled in a special organization, or the like.

In the electronic receipt information table 613, a single or a plurality of pieces of purchase information are associated and stored for each electronic receipt member ID 2131. The purchase information indicates merchandise relating to one transaction that the customer purchases.

The communication interface 62 is an interface for connection to respective devices, through a network such as the Internet.

The control unit 63 controls the operation of the entire electronic receipt server 60 so as to achieve various functions included in the control unit 63. The control unit 63 includes a CPU, a ROM, and a RAM. The CPU performs control of the operations of the electronic receipt server 60. The ROM is a storage medium that stores various programs and data. The RAM is a storage medium that temporarily stores the various programs, or for rewriting various data. The CPU executes programs stored in the ROM or the storage unit 61, with the RAM as a work area.

Since the CPU of the control unit 63 executes the control program 611 of the storage unit 61 in the RAM, the CPU implements each functional unit illustrated in FIG. 12. Specifically, the control unit 63 includes a communication control unit 631 and an electronic receipt management unit 632, as functional units, and the program steps executed by each of the functional unites are further described below.

The communication control unit 631 controls the communication interface 62 so as to communicate with respective devices which are connected to the network.

The electronic receipt management unit 632 stores the electronic receipt member ID 2131 transmitted from a point of sales (POS) terminal and purchase information in the electronic receipt information table 613. Further, if the communication control unit 631 receives the electronic receipt member ID 2131, the electronic receipt management unit 632 extracts attribute information matching the received electronic receipt member ID 2131, from the member information table 612. The electronic receipt management unit 632 causes the communication control unit 631 to transmit the extracted attribute information, as a response to the electronic receipt member ID 2131, to the beacon server 30a.

In addition, the electronic receipt management unit 632 may transmit the extracted attribute information and purchase information associated with the electronic receipt member ID 2131 in the electronic receipt information table 613, as a response to the electronic receipt member ID 2131. In this case, the beacon server 30a transmits the attribute information and the purchase information to the recommendation server 70. The recommendation server 70 can perform a recommendation process for extracting a processing content corresponding to the attribute information and the purchase information.

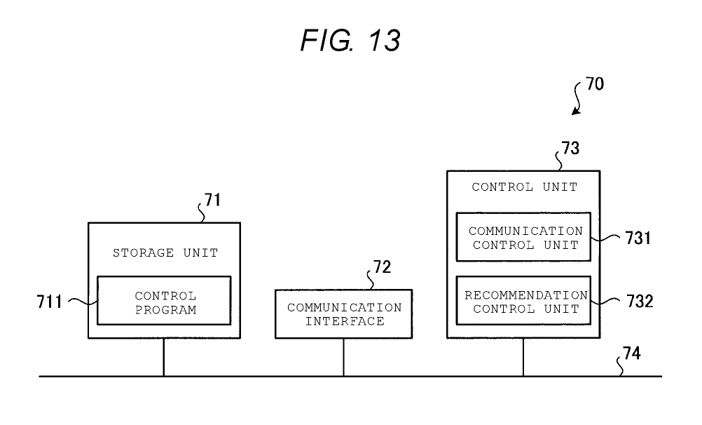

Next, the hardware configuration of the recommendation server 70 will be described. FIG. 13 is a block diagram illustrating an example of a hardware configuration of the recommendation server 70.

The recommendation server 70 includes a storage unit 71, a communication interface 72, and a control unit 73. The storage unit 71, the communication interface 72, and the control unit 73 are connected to each other through a system bus 74.

The storage unit 71 is a storage device such as an HDD or an SSD. The storage unit 71 stores a control program 711.

The control program 711 performs functions included in the recommendation server 70 or an operating system.

The communication interface 72 is an interface for connection to respective devices, through a network such as the Internet.

The control unit 73 controls the operation of the entire recommendation server 70 so as to achieve various functions included in the control unit 73. The control unit 73 includes a CPU, a ROM, and a RAM. The CPU performs control of the operations of the recommendation server 70. The ROM is a storage medium that stores various programs and data. The RAM is a storage medium that temporarily stores the various programs, or for rewriting various data. The CPU executes programs stored in the ROM or the storage unit 71, with the RAM as a work area.

Since the CPU of the control unit 73 executes the control program 711 of the storage unit 71 in the RAM, the CPU generates each functional unit illustrated in FIG. 13. Specifically, the control unit 73 includes a communication control unit 731 and a recommendation control unit 732, as functional units, and the program steps executed by each of the functional unites are further described below.

The communication control unit 731 controls the communication interface 72 so as to communicate with respective devices which are connected to the network.

If the communication control unit 731 receives first recommendation request information, the recommendation control unit 732 executes a recommendation process. In other words, the recommendation control unit 732 performs a recommendation process for extracting a processing content from processing content candidates, based on the attribute information contained in the first recommendation request information. If the first recommendation request information containing attribute information and purchasing information is received, the recommendation control unit 732 performs a recommendation process for extracting a processing content from processing content candidates, based on the attribute information and the purchasing information.

Here, the recommendation control unit 732 can perform the recommendation process by various methods. For example, the recommendation control unit 732 extracts the processing content of the attribute indicated by the attribute information, based on the information table in which the attribute is associated and stored for each processing content of the processing content candidate. Specifically, if there is an information table in which male is associated with the processing content A of the processing content candidate as the attribute and female is associated with the processing content B of the processing content candidate as the attribute, if the attribute information indicates male, the recommendation control unit 732 extracts the processing content A. Alternatively, the recommendation control unit 732 extracts a processing content of the attribute indicated by the attribute information, based on the sales performance. Specifically, if there are a processing content F relating to the display of signage information for introducing merchandise F and a processing content G relating to the display of signage information for introducing merchandise G as the processing content candidates, processing content relating to merchandise which is more frequently purchased by the customer having the attribute indicated by the attribute information is extracted. Alternatively, the recommendation control unit 732 extracts a processing content from processing content candidates, according to the attribute information, by other algorithms.

The conditions for extracting the processing content from the processing content candidates are not particularly limited, and it is possible to set any conditions. For example, the recommendation control unit 732 extracts a processing content for introducing merchandise corresponding to the gender of the customer. Alternatively, the recommendation control unit 732 extracts a processing content for granting a point value corresponding to the rank of the customer. Alternatively, the recommendation control unit 732 extracts a processing content for granting coupon information on a discount rate corresponding to the rank of the customer. Alternatively, the recommendation control unit 732 extracts a processing content for introducing merchandise corresponding to the preference of the customer which is determined from the purchase information or the like.

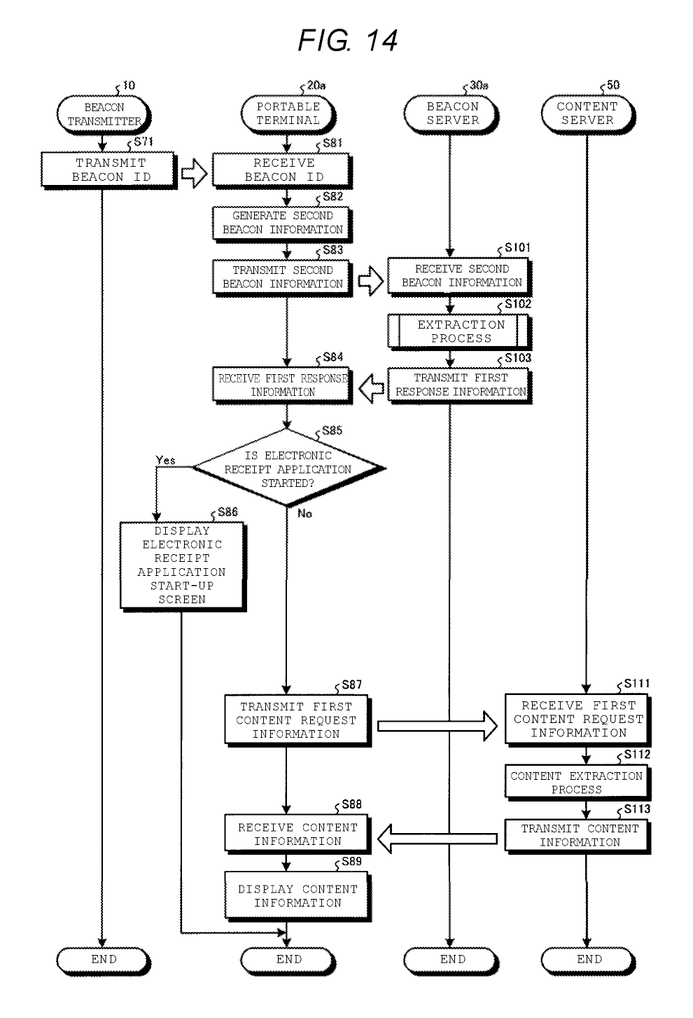

Next, a display process executed by respective devices in the beacon system 2 according to the second embodiment will be described. Here, FIG. 14 is a flowchart illustrating an example of a display process executed by respective devices in the beacon system 2 according to the second embodiment.

The processes from step S71 to step S81 are the same as the processes from step S11 to step S21 according to the first embodiment.

In step S82, the beacon control unit 263a of the portable terminal 20a generates second beacon information (step S82). Next, the second communication control unit 262 of the portable terminal 20a transmits the second beacon information (step S83).

Next, the communication control unit 331 of the beacon server 30a receives the second beacon information (step S101). Next, the beacon server 30a executes an extraction process according to the second embodiment, which will be described later (step S102).

The processes from step S103 to step S84 are the same as the processes from step S33 to step S24 according to the first embodiment.

Next, the beacon control unit 263a of the portable terminal 20a determines whether or not the processing content indicated by the received first response information requests start-up of an electronic receipt application (step S85). For example, in order to enable the start-up of the electronic receipt application with a simple operation, if the beacon ID 111 is received from the from beacon transmitter 10 which is located near the POS terminal of a retail store, the beacon control unit 263a is requested to start up the electronic receipt application. If the first response information requests start-up of the electronic receipt application (step S85; Yes), the display control unit 264 of the portable terminal 20a displays an electronic receipt application start-up screen G31 (step S86).

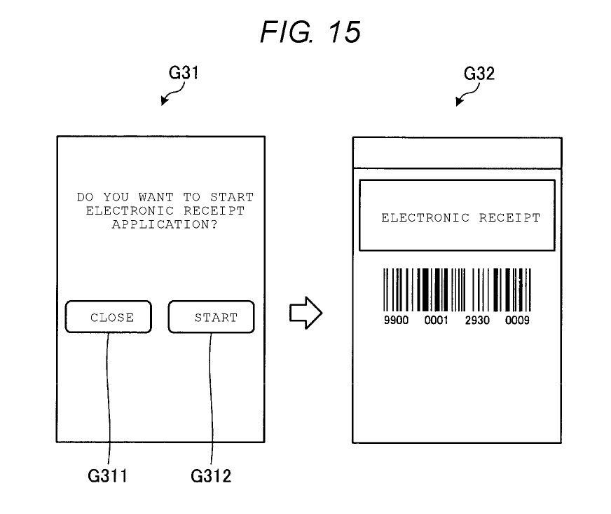

Here, FIG. 15 is an explanatory diagram illustrating an example of screen transition of the electronic receipt application start-up screen G31. The electronic receipt application start-up screen G31 is a screen for checking whether or not the electronic receipt application is started. The electronic receipt application start-up screen G31 includes a close button G311 and a start button G312. The close button G311 is a button for refusing the start-up of the electronic receipt application. The start button G312 is a button for allowing the start-up of the electronic receipt application. If the start button G312 is pressed, the display control unit 264 displays an electronic receipt member ID screen G32. The electronic receipt member ID screen G32 displays an electronic receipt member ID 2131 and an image obtained by converting the electronic receipt member ID 2131 into a code symbol. For example, a POS terminal that issues an electronic receipt reads the code symbol of the electronic receipt member ID 2131 which is displayed on the electronic receipt member ID screen G32. The POS terminal issues an electronic receipt for the electronic receipt member ID 2131. In other words, locating the beacon transmitter 10 relating to the request for the start-up of the electronic receipt application near the POS terminal allows a customer to display the electronic receipt member ID screen G32 with a simple operation.

Returning to FIG. 14, if the first response information does not request the start-up of the electronic receipt application (step S85; No), the second communication control unit 262 of the portable terminal 20a transmits first content request information (step S87).

The processes from step S111 to step S88 are the same as the processes from step S41 to step S26 according to the first embodiment.

Next, the display control unit 264 of the portable terminal 20a displays the received content information (step S89).

Thus, the display process executed by respective devices in the beacon system 2 according to the second embodiment is ended.

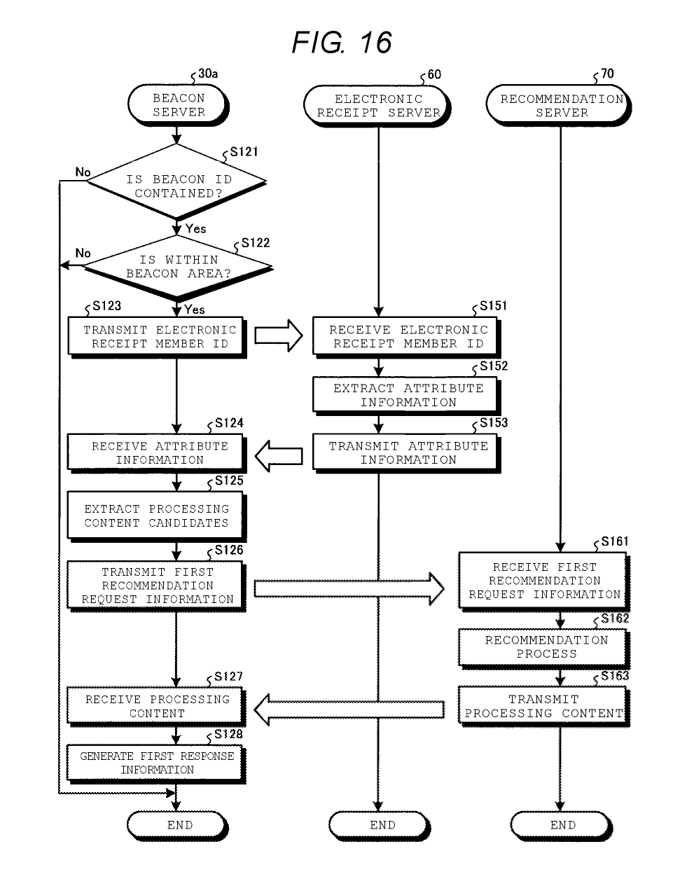

Next, an extraction process executed by the beacon server 30a, the electronic receipt server 60, and the recommendation server 70 in the beacon system 2 according to the second embodiment will be described. Here, FIG. 16 is a flowchart illustrating an example of an extraction process executed by respective devices in the beacon system 2 according to the second embodiment.

The processes from step S121 and step S122 are the same as the processes from step S51 and step S52 according to the first embodiment.

The communication control unit 331 of the beacon server 30a transmits the electronic receipt member ID 2131 contained in the received second beacon information, to the electronic receipt server 60 (step S123).

Next, the communication control unit 631 of the electronic receipt server 60 receives the electronic receipt member ID 2131 (step S151). Next, the electronic receipt management unit 632 of the electronic receipt server 60 extracts attribute information associated with the received electronic receipt member ID 2131 (step S152). Next, the communication control unit 631 of the electronic receipt server 60 transmits the attribute information (step S153).

Next, the communication control unit 331 of the beacon server 30a receives the attribute information (step S124).

Next, the response information generation unit 332a of the beacon server 30a extracts the processing content candidates associated with the beacon ID 111 (step S125). Next, the communication control unit 331 of the beacon server 30a generates first recommendation request information containing the attribute information and the processing content candidates, and transmits the generated first recommendation request information to the recommendation server 70 (step S126).

Next, the communication control unit 731 of the recommendation server 70 receives the first recommendation request information (step S161). Next, the recommendation control unit 732 of the recommendation server 70 performs a recommendation process for extracting a processing content from processing content candidates contained in the first recommendation request information, based on the attribute information contained in the first recommendation request information (step S162). Next, the communication control unit 731 of the recommendation server 70 transmits the extracted processing content (step S163).

Next, the communication control unit 331 of the beacon server 30a receives the processing content (step S127). Next, the response information generation unit 332a of the beacon server 30a generates first response information containing the processing content received in step S127 (step S128).

Thus, the extraction process executed by respective devices in the beacon system 2 according to the second embodiment is ended.

As described above, in the portable terminal 20a according to the second embodiment, it is possible to display the content information corresponding to the attribute information of the customer. Thus, the portable terminal 20a can easily perform marketing for the visiting customer. In addition, the portable terminal 20a can easily perform marketing corresponding to the customer.

### Third Embodiment

Next, a beacon system 3 according to a third embodiment will be described. In the following description, a difference from the second embodiment will be mainly described. The components having the same function as in the second embodiment are denoted by the same names and reference numerals as in the second embodiment, and the description thereof will be omitted.

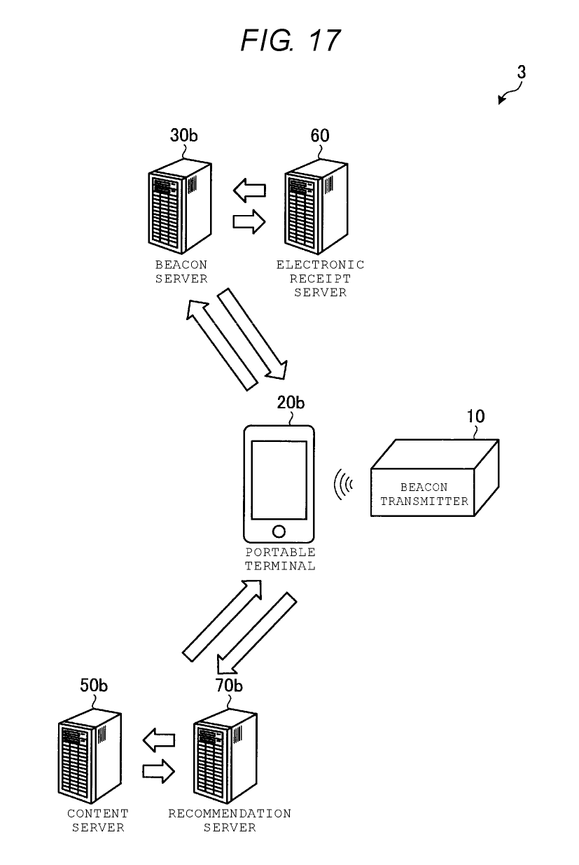

Here, FIG. 17 is an explanatory diagram illustrating an example of a configuration of the beacon system 3 according to the third embodiment. The beacon system 3 includes a portable terminal 20b, a beacon server 30b, a content server 50b, and a recommendation server 70b, instead of the portable terminal 20a, the beacon server 30a, the content server 50, and the recommendation server 70. In the beacon system 3, the content server 50b and the recommendation server 70b extracts the content information corresponding to the attribute information of a customer, in association with each other.

Next, the hardware configuration of respective devices included in the beacon system 3 according to the third embodiment will be described.

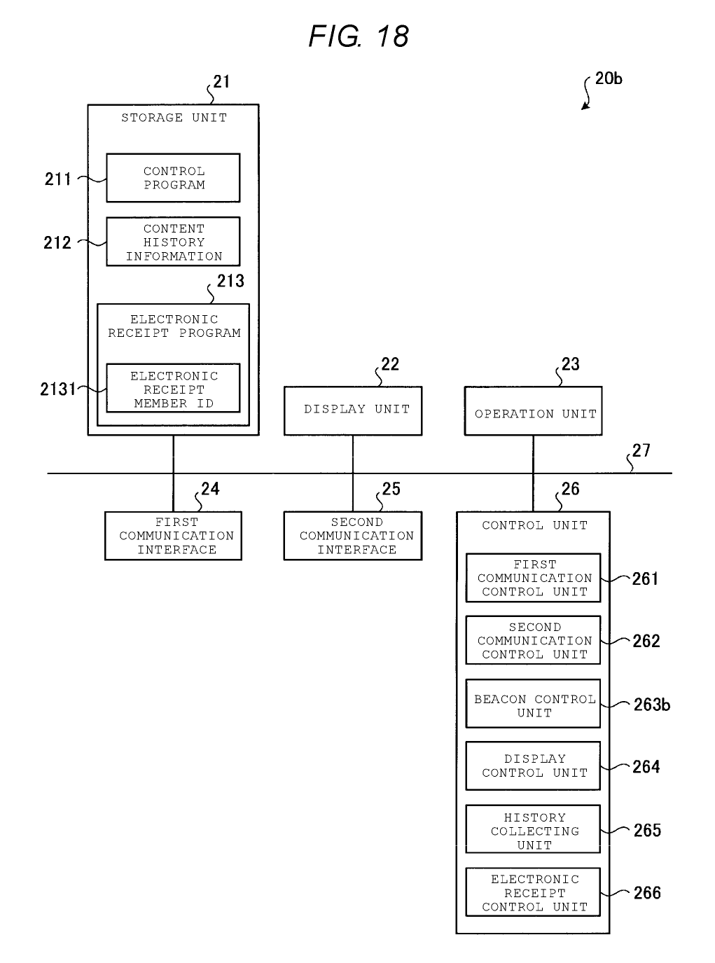

The hardware configuration of the portable terminal 20b according to the third embodiment will be described. FIG. 18 is a block diagram illustrating an example of the hardware configuration of the portable terminal 20b according to the third embodiment.

The beacon control unit 263b according to the third embodiment causes the second communication control unit 262 which is a third transmission unit, to transmit second beacon information. In other words, the beacon control unit 263b causes the second communication control unit 262 to transmit the electronic receipt member ID 2131 contained in the second beacon information, to the electronic receipt server 60, through the beacon server 30b. Further, the beacon control unit 263b causes the second communication control unit 262 to transmit the beacon ID 111 contained in the second beacon information and the beacon strength to the beacon server 30b.

If the second beacon information is transmitted, the beacon control unit 263b causes the second communication control unit 262 which is a fourth reception unit to receive second response information which is transmitted from the beacon server 30. Here, the second response information further contains the attribute information in addition to the first response information. In other words, the second response information contains the processing content associated with the beacon ID 111 and the attribute information. The beacon control unit 263b causes the second communication control unit 262 to transmit second content request information containing the processing content indicated by the second response information and the attribute information. Here, the second content request information requests content information corresponding to the processing content indicated by the second response information and the attribute information. The beacon control unit 263b causes the second communication control unit 262 to receive content information on processing content corresponding to the attribute information, as the response to the second content request information. The beacon control unit 263b causes the display control unit 264 to display the content information, if the second communication control unit 262 receives content information.

In addition, if second response information containing the attribute information and the purchasing information is received, the beacon control unit 263b causes the second communication control unit 262 to transmit second content request information containing the processing content, the attribute information, and the purchasing information. In this case, the recommendation server 70b can perform a recommendation process for extracting content information, which corresponds to the attribute information and the purchase information.

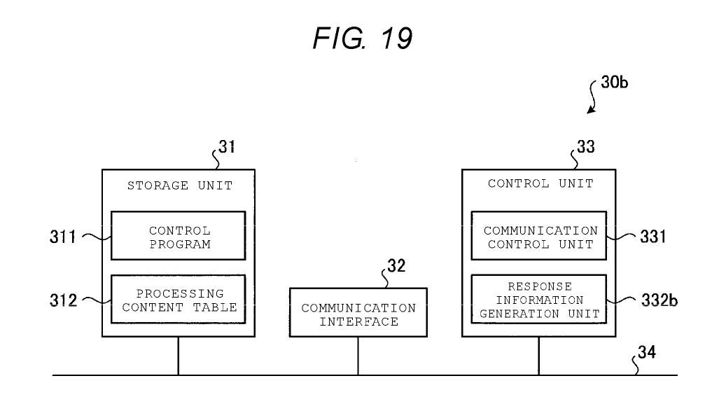

The hardware configuration of the beacon server 30b according to the third embodiment will be described. FIG. 19 is a block diagram illustrating an example of the hardware configuration of the beacon server 30b according to the third embodiment.

Similar to the processing content table 312 according to the first embodiment, a beacon area and a processing content are associated and stored for each beacon ID 111 in the processing content table 312 according to the third embodiment.

The response information generation unit 332b according to the third embodiment generates second response information containing attribute information and the processing content. If the corresponding attribute information and the purchasing information are transmitted, the response information generation unit 332b generates second response information containing attribute information, purchasing information, and a processing content, as a response to the electronic receipt member ID 2131. In this case, the recommendation server 70b can perform a recommendation process for extracting content information, which corresponds to the attribute information and the purchase information.

In addition, in the present embodiment, a description is given, with the beacon server 30b, the content server 50b, the electronic receipt server 60, and the recommendation server 70b as separate server devices, but it is not limited thereto. For example, a single server device may achieve the functions of the beacon server 30b and the electronic receipt server 60, and another server device may achieve the functions of the content server 50b and the recommendation server 70b.

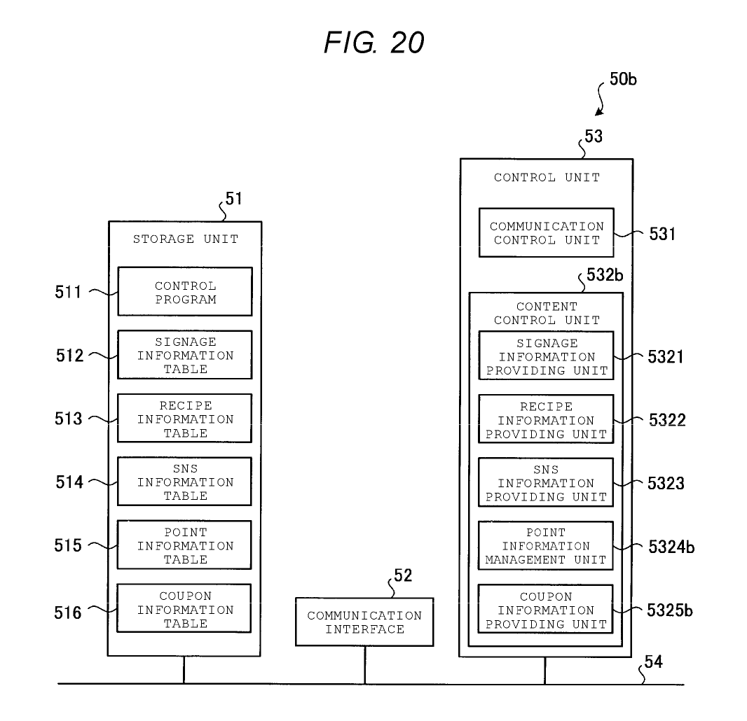

The hardware configuration of the content server 50b according to the third embodiment will be described. FIG. 20 is a block diagram illustrating an example of the hardware configuration of the content server 50b according to the third embodiment.

The content control unit 532b according to the third embodiment extracts content information corresponding to the second content request information, in cooperation with function units included in the content control unit 532b. Specifically, the content control unit 532b extracts a single piece or a plurality of pieces of content candidate information corresponding to the processing content of the second content request information. Here, the content candidate information is content information which is a candidate of the content information to be transmitted to the portable terminal 20a. The content control unit 532b generates second recommendation request information containing the extracted single piece or plurality of pieces of content candidate information and the attribute information contained in the second content request information. The content control unit 532b causes the communication control unit 531 to transmit the generated second recommendation request information, to the recommendation server 70b. Thus, the content control unit 532b extracts content information corresponding to the processing content of the second content request information and the attribute information. The content control unit 532b receives the content information from the recommendation server 70b. If the second content request information contains purchasing information, the content control unit 532b generates second recommendation request information containing the extracted single piece or plurality of pieces of content candidate information, the attribute information, and the purchasing information.

If the communication control unit 531 receives second content request information on point granting, the point information management unit 5324b grants a point to a corresponding customer in the point information table 515. Further, the point information management unit 5324b can grant different point value, depending on the attribute information contained in the second content request information. For example, the point information management unit 5324b can grant a point corresponding to the rank of the customer indicated by the attribute information.

If the communication control unit 531 receives second content request information on coupon information granting, the coupon information providing unit 5325b grants coupon information to a corresponding customer in the coupon information table 516. Further, the coupon information providing unit 5325b can grant different coupon information, depending on the attribute information contained in the second content request information. For example, the coupon information providing unit 5325b can grant coupon information corresponding to the rank of the customer indicated by the attribute information. More specifically, the coupon information providing unit 5325b grants coupon information having a different discount rate depending on the attribute information, or grants coupon information forgiving different goods depending on the attribute information.

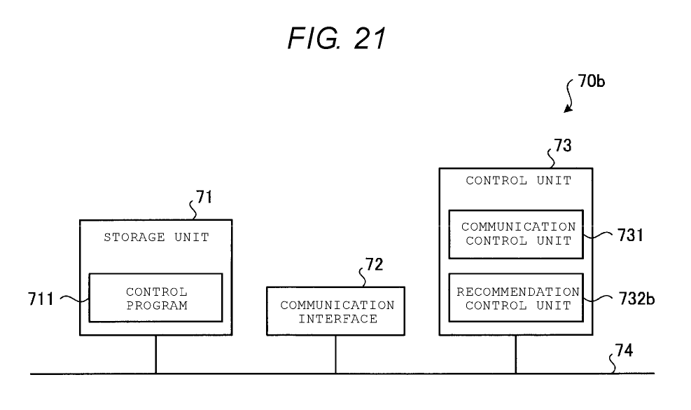

The hardware configuration of the recommendation server 70b according to the third embodiment will be described. FIG. 21 is a block diagram illustrating an example of the hardware configuration of the recommendation server 70b according to the third embodiment.

If the communication control unit 331 receives second recommendation request information, the recommendation control unit 732b according to the third embodiment executes a recommendation process. In other words, the recommendation control unit 732b performs a recommendation process for extracting content information from content candidate information, based on the attribute information contained in the second recommendation request information. If the second recommendation request information containing attribute information and purchasing information is received, the recommendation control unit 732b performs a recommendation process for extracting content information from content candidate information, based on the attribute information and the purchasing information.

Here, the recommendation control unit 732b performs the recommendation process by various methods. For example, the recommendation control unit 732b extracts the content information of the attribute indicated by the attribute information, based on the information table in which the attribute is associated and stored for each piece of content information of content candidate information. Specifically, if there is an information table in which male is associated with the content information A of the content candidate information as the attribute and female is associated with the content information B of the content candidate information as the attribute, if the attribute information indicates male, the recommendation control unit 732b extracts the content information A. Alternatively, the recommendation control unit 732b extracts content information of the attribute indicated by the attribute information, based on the sales performance. Specifically, if there are content information F on the display of signage information for introducing merchandise F and content information G relating to the display of signage information for introducing merchandise G as the content candidate information, content information on merchandise which is more frequently purchased by the customer having the attribute indicated by the attribute information is extracted. Alternatively, the recommendation control unit 732b extracts content information from content candidate information, based on the attribute information, by other algorithms.

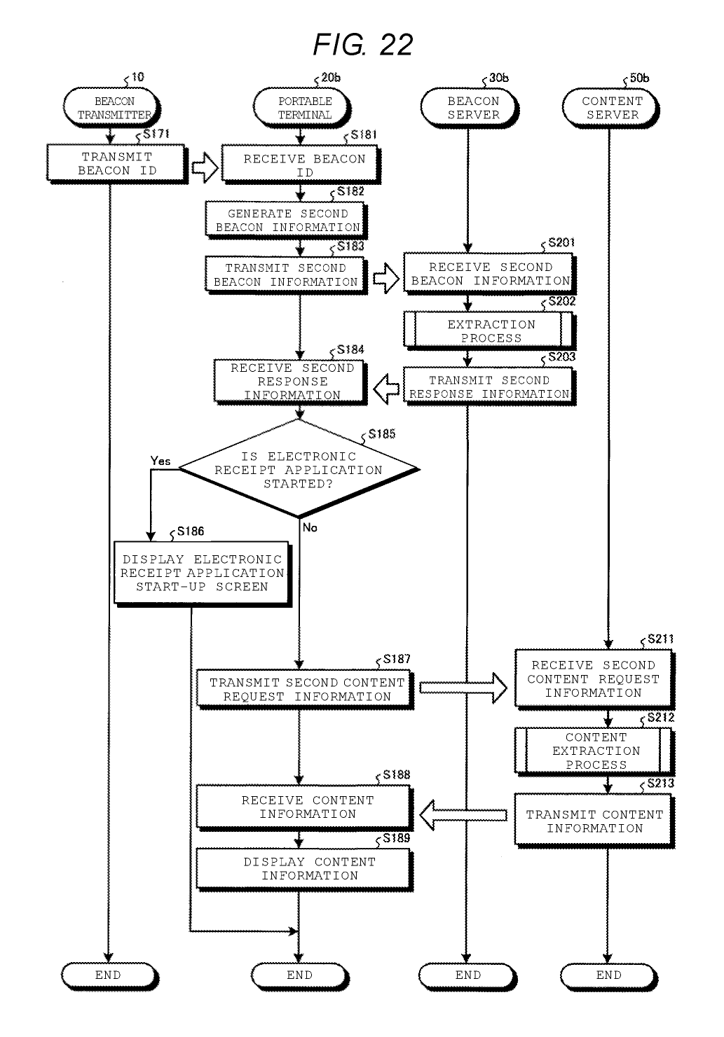

Next, a display process executed by respective devices in the beacon system 3 according to the third embodiment will be described. Here, FIG. 22 is a flowchart illustrating an example of a display process executed by respective devices in the beacon system 3 according to the third embodiment.

The processes from step S171 to step S201 are the same as the processes from step S71 to step S101 according to the second embodiment.

In step S202, the beacon server 30b executes an extraction process according to the third embodiment, which will be described later (step S202).

The following processes from step S203 to step S186 are the same as the processes from step S103 to step S86 according to the second embodiment.

Next, the beacon control unit 263b of the portable terminal 20b transmits the second content request information (step S187).

Next, the communication control unit 531 of the content server 50b receives second content request information (step S211). Next, the content server 50b executes a content extraction process according to the third embodiment, which will be described later (step S212).

The processes from step S213 to step S189 are the same as the processes from step S113 to step S89 according to the second embodiment.

Thus, the display process executed by respective devices in the beacon system 3 according to the third embodiment is ended.

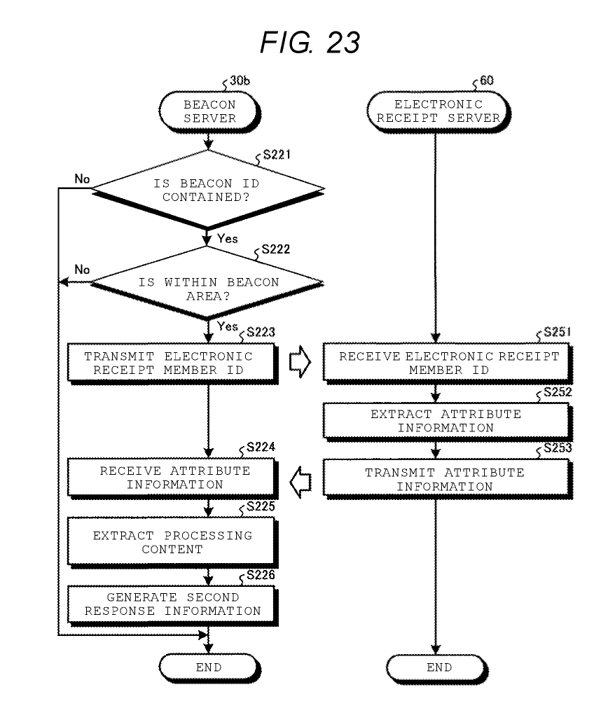

Next, an extraction process executed by the beacon server 30b and the electronic receipt server 60 in the beacon system 3 according to the third embodiment will be described. Here, FIG. 23 is a flowchart illustrating an example of an extraction process executed by respective devices in the beacon system 3 according to the third embodiment.

The processes from step S221 to step S224 are the same as the processes from step S121 to step S124 according to the second embodiment.

Next, the response information generation unit 332b of the beacon server 30b extracts a processing content (step S225). Next, the response information generation unit 332b of the beacon server 30b generates second response information (step S226).

Thus, the extraction process executed by respective devices in the beacon system 3 according to the third embodiment is ended.

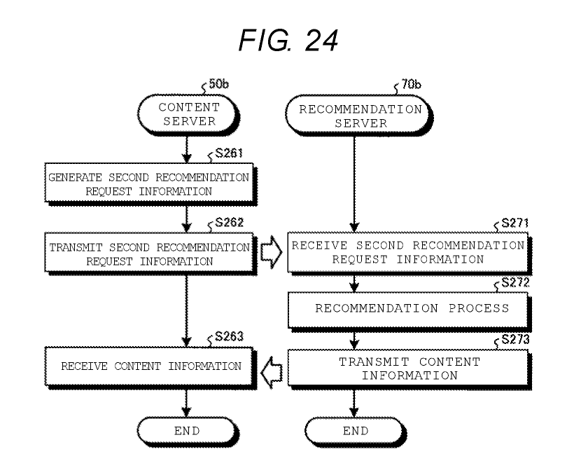

Next, a content extraction process executed by the content server 50b and the recommendation server 70b in the beacon system 3 according to the third embodiment will be described. Here, FIG. 24 is a flowchart illustrating an example of the content extraction process executed by respective devices in the beacon system 3 according to the third embodiment.

The content control unit 532b of the content server 50b generates second recommendation request information containing a single piece or a plurality of pieces of content candidate information corresponding to the processing content and the attribute information (step S261). Next, the communication control unit 531 of the content server 50b transmits the second recommendation request information (step S262).

Next, the communication control unit 731 of the recommendation server 70b receives the second recommendation request information (step S271). Next, the recommendation control unit 732b of the recommendation server 70b performs a recommendation process for extracting content information from content candidate information contained in the second recommendation request information, based on the attribute information contained in the second recommendation request information (step S272). Next, the communication control unit 731 of the recommendation server 70b transmits the extracted content information (step S273).

Next, the communication control unit 531 of the content server 50b receives the content information (step S263).

Thus, the content extraction process executed by respective devices in the beacon system 3 according to the third embodiment is ended.

As described above, in the portable terminal 20b according to the third embodiment, it is possible to display the content information corresponding to the attribute information of the customer. Thus, the portable terminal 20b can easily perform marketing for the visiting customer. In addition, the portable terminal 20b can easily perform marketing corresponding to the customer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

In addition, in the description of the embodiments, the portable terminals 20, 20a, and 20b store the history of the content information that a customer viewed in the content history information 212. However, the portable terminals 20, 20a, and 20b may store content information, as well as the history of the content information.

Further, the recommendation server 70 according to the second embodiment extracts a processing content from the processing content candidates, in cooperation with the beacon server 30a. The recommendation server 70b according to the third embodiment extracts content information from the content information candidates, in cooperation with the content server 50b. Thus, in the respective embodiments, the portable terminals 20, 20a, and 20b display content information according to the attribute information. However, the recommendation servers 70 and 70b may cooperate with not only any one of the beacon server 30a and content server 50b, but also the respective beacon server 30a and content server 50b. In other words, the recommendation servers 70 and 70b may extract a processing content from the processing content candidate in cooperation with the beacon server 30a, and extract content information from the content information candidates in cooperation with the content server 50b.

It is assumed that the program executed by each device in the above embodiments or the modification example is provided by being incorporated in advance into a storage medium (a ROM or a storage unit) provided in each device, but it is not limited thereto. For example, the program may be provided by being recorded in a computer readable recording medium such as a CD-ROM, a flexible disk (FD), a CD-R, and a digital versatile disk (DVD), as a file with an installable form or an executable form. In addition, the storage medium is not limited to a media independent of a computer or an embedded system, and includes a storage medium in which a program transmitted through a LAN, the Internet, or the like and downloaded is stored or temporarily stored.

Further, the program executed by each device in the embodiments and the modification example may be provided by being stored in a computer connected to a network such as the Internet, and downloaded through the network, or may be provided or distributed through a network such as the Internet.

What is claimed is:

1. A beacon system that improves relevance of content delivered to a display device, comprising:
a plurality of beacon transmitters at different locations, each beacon transmitter configured to wirelessly transmit a unique beacon ID signal using a short distance wireless communication protocol;
a first server device;
a second server device; and
a portable terminal having a first communication interface configured to wirelessly communicate with other devices using the short distance wireless communication protocol, and a second communication interface configured to wirelessly connect to a network for communication with the first and second server devices, wherein
the portable terminal, in response to receiving through the first communication interface, a unique beacon ID signal from one of the transmitters at a first location, generates a first request signal from the unique beacon ID signal, and transmits the first request signal to the first server device,
the first server device, in response to the first request signal, generates a first response signal, and transmits the first response signal to the portable terminal,
the portable terminal, in response to receiving through the second communication interface, the first response signal, generates a second request signal from the first response signal, and transmits the second request signal to the second server device,
the second server device, in response to the second request signal, generates a second response signal, and transmits the second response signal to the portable terminal,
the portable terminal, in response to receiving through the second communication interface, the second response signal, displays content that is relevant to the first location on a display unit thereof.

2. The beacon system according to claim 1, wherein the first server device, in response to the first request signal, determines that the portable terminal is within a predetermined distance from the first location, prior to generating the first response signal.

3. The beacon system according to claim 2, wherein the portable terminal, in response to receiving through the second communication interface, the first response signal, displays a prompt to launch an electronic receipt application installed therein.

4. The beacon system according to claim 3, wherein the first location is within a predetermined proximity to a point-of-sale terminal.

5. The beacon system according to claim 1, further comprising:
a third server device that tracks purchases made by a user of the portable terminal; and
a fourth server device that generates recommendations based on purchase history, wherein
the portable terminal is configured to add an electronic receipt member ID of the user to the first request signal, and
the first server device communicates with the third server device and the fourth server device to acquire recommendations based on the purchase history correlated to the electronic receipt member ID and transmit the recommendations to the portable terminal for display by the display unit of the portable terminal.

6. A method of delivering relevant content to a display device in a beacon system including a plurality of beacon transmitters at different locations, each beacon transmitter configured to wirelessly transmit a unique beacon ID signal using a short distance wireless communication protocol, a first server device, a second server device, and a portable terminal having a first communication interface configured to wirelessly communicate with other devices using the short distance wireless communication protocol, and a second communication interface configured to wirelessly connect to a network for communication with the first and second server devices, said method comprising:
at the portable terminal, in response to receiving through the first communication interface, a unique beacon ID signal from one of the transmitters at a first location, generating a first request signal from the unique beacon ID signal, and transmitting the first request signal to the first server device;
at the first server device, generating a first response signal in response to the first request signal, and transmitting the first response signal to the portable terminal;
at the portable terminal, in response to receiving through the second communication interface, the first response signal, generating a second request signal from the first response signal, and transmitting the second request signal to the second server device;
at the second server device, generating a second response signal in response to the second request signal, and transmitting the second response signal to the portable terminal;
at the portable terminal, in response to receiving through the second communication interface, the second response signal, displaying content that is relevant to the first location on a display unit thereof.

7. The method according to claim 6, further comprising:
at the first server device, prior to generating the first response signal, determining that the portable terminal is within a predetermined distance from the first location in response to the first request signal.

8. The method according to claim 7, further comprising:
at the portable terminal, in response to receiving through the second communication interface, the first response signal, displaying a prompt to launch an electronic receipt application installed therein.

9. The method according to claim 8, wherein the first location is within a predetermined proximity to a point-of-sale terminal.

10. The method according to claim 6, wherein the beacon system further includes a third server device that tracks purchases made by a user of the portable terminal, and a fourth server device that generates recommendations based on purchase history, and wherein the method further comprises:
at the portable terminal, adding an electronic receipt member ID of the user to the first request signal; and
at the first server device, communicating with the third server device and the fourth server device to acquire recommendations based on the purchase history correlated to the electronic receipt member ID, and transmitting the recommendations to the portable terminal for display by the display unit of the portable terminal.
